(19) United States
(12) Patent Application Publication
(10) Pub. No.: US 2014/0195041 A1
(43) Pub. Date: Jul. 10, 2014

(54) METHOD OF SENSING A DELIVERED PRODUCT IN A SNACK VENDING MACHINE

(71) Applicant: Ronald A. Hoormann, St. Charles, MO (US)

(72) Inventor: Ronald A. Hoormann, St. Charles, MO (US)

(73) Assignee: COIN ACCEPTORS, INC., St. Louis, MO (US)

(21) Appl. No.: 13/430,652

(22) Filed: Mar. 26, 2012

Related U.S. Application Data
(60) Provisional application No. 61/467,781, filed on Mar. 25, 2011.

(51) Int. Cl. G06F 17/00; G07F 11/62

(52) U.S. Cl. 700/232; 221/192

(57) ABSTRACT

A dispensed product detection system and method for use in a vending machine where the products are hold on shelves and utilizing an optical light beam crossing the path through which a dispensed product travels.

### BACKGROUND OF THE INVENTION

1. Field of the Invention

In the field of unattended point of sale transactions involving verification of credit cards, bills, coins and the like, there are various methods for retrieving and dispensing a vendible product for presentation to the purchaser. The present invention relates to a method and apparatus for detecting the product in its way to a customer accessible bin for retrieval.

2. Description of the Related Art

The present invention relates generally to an apparatus and method for the detection of the dispensing of a product from a vending machine, and in particular to, an optical detection system utilizing an infrared beam transmitted from an emitter, to a detector, the path of which is broken by a product as it is dispensed from the vending machine, thereby generating a detectable signal.

Traditionally, vending machines for canned or packaged goods include a sensing mechanism designed to detect the impact of a dispensed product or package deposited in a chute or bin, such as is shown in U.S. Pat. No. 5,927,539 to Truitt et al. for a modular vending machine equipped with a dispensing detection device.

These traditional impact sensors are sensitive to the impact of the falling product in terms of whether there is a soft or hard impact, with hard impacts being easier to detect. Lightweight products which result in soft impacts having lower forces are difficult to detect, and accordingly, traditional impact sensors must be capable of sensing impacts varying over a wide range of forces, often with a reduction in reliability for detecting the impact of lightweight products. In the event the dispensing of a lightweight product is not properly detected by a traditional impact sensor, the vending machine is likely to dispense a second product, or to “double-vend”, resulting in an error condition requiring a service person or route manager to take corrective action.

Alternative types of sensors to register the vending or dispensing of a product, such as photoelectric sensors, magnetic sensors, piezo-electric sensors, and optical or acoustic sensors are known, such as are disclosed in U.S. Pat. No. 4,359,147 and in U.S. Pat. No. 4,252,250.

Coin Acceptors, Inc.'s Patent No. U.S. Pat. No. 6,629,625 describes a system where a light emitter transmits a light beam across the product path to a low-loss reflector tolerant of beam misalignment, where the beam is reflected back to an optical detector located adjacent the emitter.

### BRIEF SUMMARY OF THE INVENTION

Briefly stated, the preferred embodiment of the present invention first discloses a detection system and method utilizing an optical beam crossing the path through which a dispensed product travels and enters into a delivery bin.

Secondly the invention discloses an improved customer receivable bin that funnels the incoming product.

Another aspect of the invention discloses an algorithm for moving the product holding spirals based on the output state of the product delivery sensor.

Further more the invention discloses an innovative method of calibrating the optical sensor to compensate for environmental and component inaccuracies.

### BRIEF DESCRIPTION OF THE DRAWINGS

Referring now to the drawings in which like reference numbers represent corresponding parts throughout:

FIG. 1 is a drawing depicting the main elements of typical Vending Machine with product on shelves as seen from the outside;

FIG. 2 is a drawing depicting the main elements of typical Vending Machine with product on shelves as seen with the front door open;

FIG. 3 is a detailed view of the customer retrievable bin viewed from the inside of the Vending Machine; the drawing depicts in a visible way an array of infrared optical beams located just above the customer retrievable bin as been seen in other prior art embodiments;

FIG. 4 is a detailed view of the customer retrievable bin viewed from the inside of the Vending Machine; the bin components creating the product funnel could be seen from the above;

FIG. 5 is a detailed view of the customer retrievable bin with components creating the product funnel and with the optical beam located at the exit of the funnel; the infrared optical beam is represented in a visible way for representation purpose only;

FIG. 6 is a side view drawing of the customer retrievable bin showing the components that create the funnel and the solenoid activated mechanism that holds these components in the preferred position;

FIG. 7 is a flowchart representation of the algorithm of moving and stopping the rotation of the spiral after the delivery of the product and in correspondence with the state of the optical sensor located at the bottom of the product delivery funnel;

FIG. 8 shows in diagram representation two possible arrangements of the optical components at the bottom of the funnel;

FIG. 9 is a flowchart representation of the Sensor Calibration/Product detection routine.

### DETAILED DESCRIPTION OF PREFERRED EMBODIMENT

In the following description, reference is made to the accompanying drawings which form a part hereof, and which is shown, by way of illustration, several embodiments of the present invention. It is understood that other embodiments may be utilized and structural changes may be made without departing from the scope of the present invention.

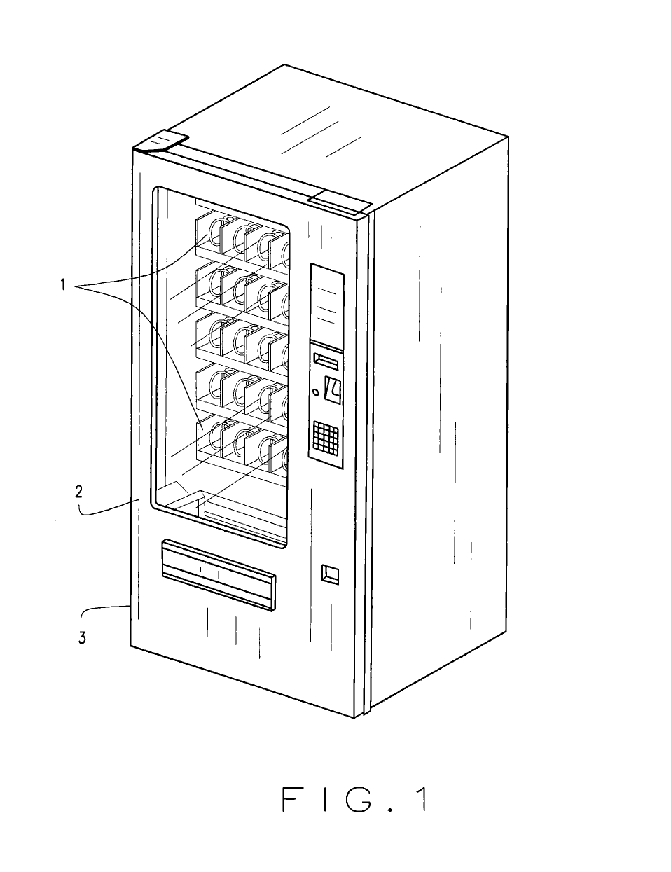

Referring now to FIG. 1 wherein is a drawing depicting a glass front vending machine with products on shelves. Through the front window the five shelves, 1 are visible. Every shelf has a number of cells and every cell has a spiral for loading and delivering the product. Spirals are rotated from the back by D.C. motors not visible in this figure. Motors are controlled by the Vending Machine Controller, VMC. Means for detecting a full rotation of the spiral are attached to the motor and their output is transmitted to the VMC.

Other means for rotation of the spirals are available, e.g. the means described in the patent application Ser. No. 11/679,797 and publication US2007/0199951.

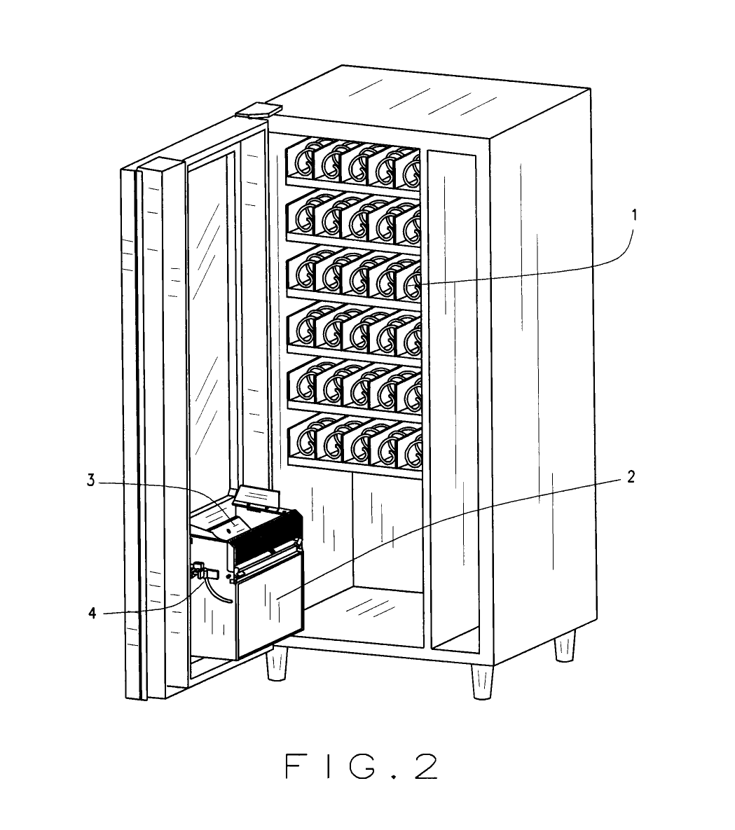

As the spiral rotates the product loaded into the helical coil spiral is driven of the shelf and drops into the customer retrievable bin, 2, and could be retrieved by the customer via front door 3. Note that the VMC is not visible in FIG. 1 or in FIG. 2 because is located behind the solid portion of the Vending Machine.

Referring now to FIG. 2 wherein a drawing depicting the vending machine with the glass front door opened, the number of shelves 1 was increased to six. The customer retrievable bin 2 is seen from the inside of the vending machine. Product falling from any shelf will go through the opening 3 into the bin and could eventually be retrieved by opening the outside door of the bin not visible in this figure. Mechanism 4 located on the right side of the bin could hold the upper door of the bin open or closed.

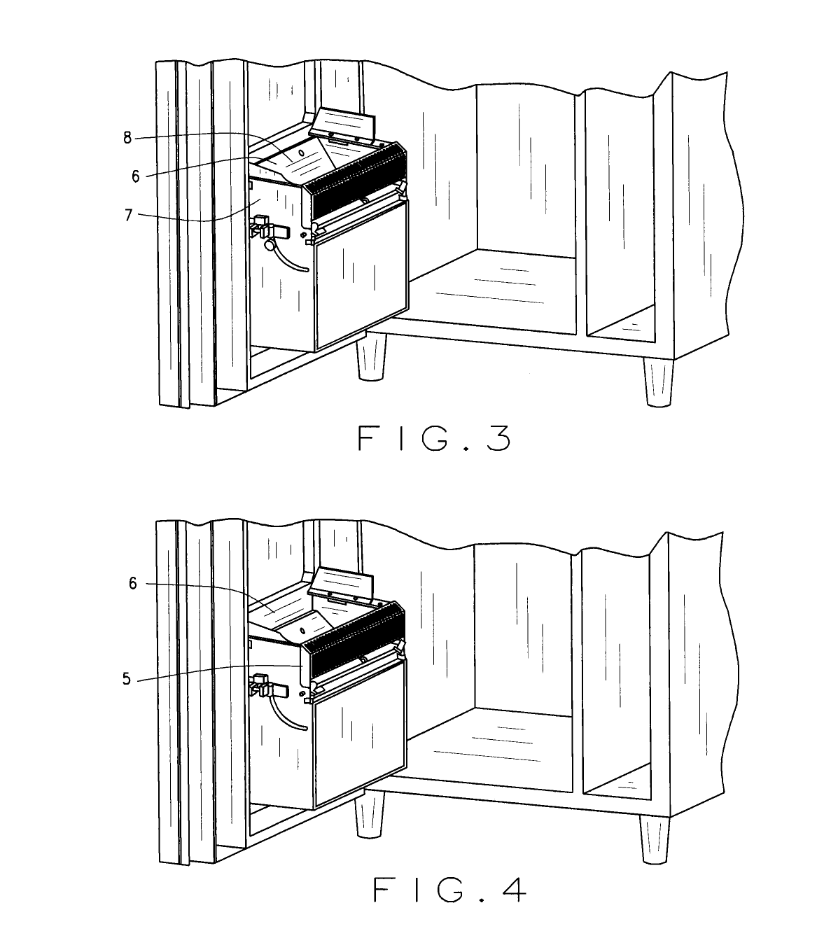

Referring now to FIG. 3 and FIG. 6 wherein details of the customer retrievable bin are depicted, the functionality of the customer retrievable bin, per one of the embodiments of the present invention is as follow. In a steady state, just before any product is being vended, the customer retrievable bin doors 6 and 3 in FIG. 6 and item 6 in FIG. 3 are in closed position. Mechanism 5, Solenoid 4 and Switch 7 cooperate to maintain this closed position. Note that in FIG. 3 only door 6 is visible the other one being masked out by the bin right side view 7. When a product is vended and it drops from one of the cells located on one of the shelves, it will fall on the top of door 6. The door is equipped with means for detected the dropped product. Some possible means are described in our US patent No. U.S. Pat. No. 4,359,147. FIG. 3, item 8 depicts other means for detecting the dropped product, an array of optical beams located just above the door 6. When the sensor detects the product and communicates detection to the VMC, the VMC cuts the power to the Solenoid 4, door 6 and door 3 of FIG. 6 open and the product falls into the customer retrievable bin. When the customer opens door 1, mechanical linkage 2 of FIG. 6 closes the doors 6 and 3 and they will stay closed by the action of solenoid 4 and mechanism 5.

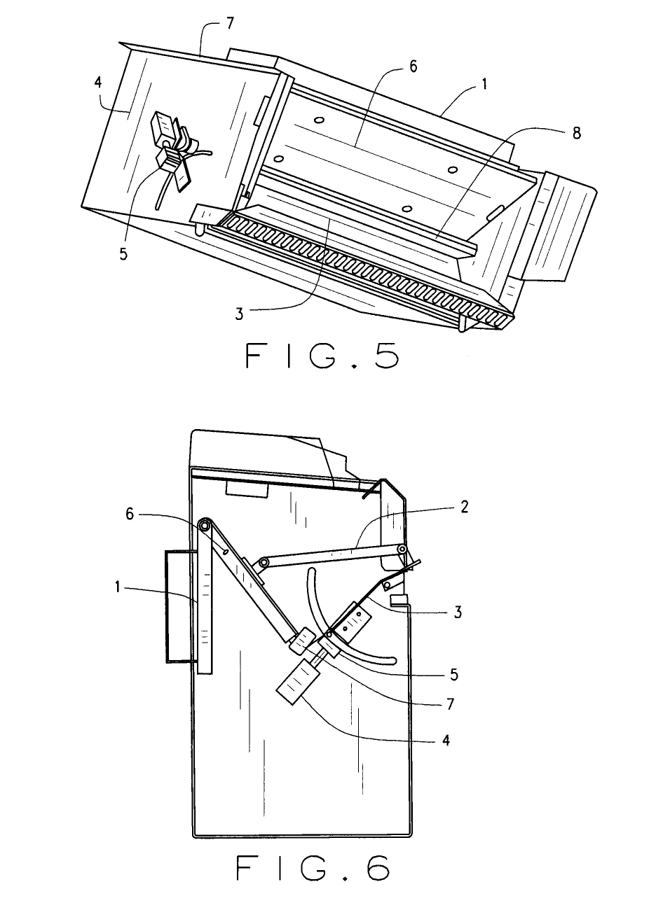

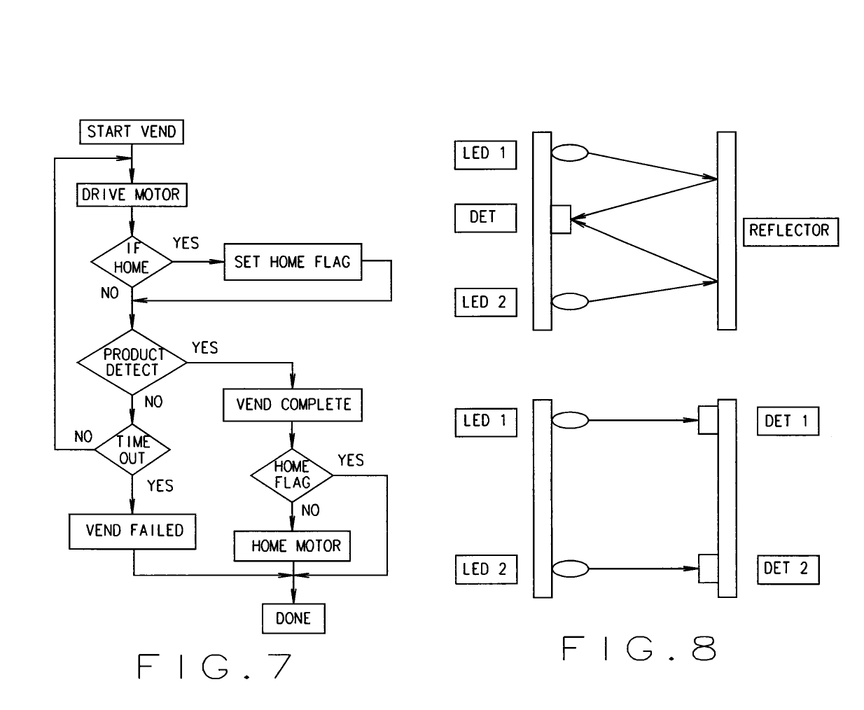

Referring now to FIG. 4 and FIG. 5 another embodiment of this invention is as follows. Doors 6 and 3 cooperate to create a funnel like opening at the entry into the customer retrievable bin. Mechanism 5 and Solenoid 4 of FIG. 5 cooperate to maintain the doors 6 and 3 in this position. Note that door 3 in FIG. 4 is not visible being masked by the side view 5 of the retrievable bin. An optical beam of infrared light is created at the bottom of the funnel. It is depicted as item 8 in the FIG. 5. FIG. 8 shows two possible arrangements of optical components to accomplish the optical beam at the bottom of the funnel. When the product is vended, it drops from the shelf being pushed by the rotating spiral. Consequently the product falls and eventually arrives into the funnel created by doors 6 and 3 at the entry into the customer retrievable bin. The product slides down the walls of the funnel, doors 6 and 3, and it riches the opening at the bottom of the funnel where is being detected by interrupting the optical beam. The detector part of the optical device changes state as no light from the LED part of the optical device riches it. The change of the detector state is sensed by the VMC. The VMC interrupts power to switch 7 of FIG. 6 or FIG. 7, solenoid 4 without power releases doors 6 and 3 that totally open. The hole at the bottom of the funnel increases and the product falls into the customer retrievable bin. When the customer opens the front door 1 to retrieve the product, linkage 2 of FIG. 6 helps doors 6 and 3 to reform the funnel. The mechanism 5 and solenoid 4 will maintain the funnel. Note that the VMC is not visible in FIG. 4 or in FIG. 5 because is located behind the solid portion of the Vending Machine.

FIG. 7 helps describing another aspect of this invention. The depicted flowchart shows how the VMC rotates the spiral for the delivery of a product and how its stops it in time to avoid the delivery of more that one item. The algorithm also resolves the issue of spiral alignment at the end of the vend cycle. When the customer makes a “selection” and inputs a credit larger or equal with the price of that “selection”, the VM Controller starts rotating the spiral of that selection until the PRODUCT DETECTION SENSOR (optical at the exit of the funnel) “detects” the product and STOPS the spiral. After the Vend, if the Vend occurred during the FIRST CYCLE the SPIRAL will be aligned. The algorithm assumes that every motor that rotates a spiral has attached means for detecting when the spiral completed 360 degrees or full rotation. The VM Controller starts the rotation of the spiral and will only stop it after the product is detected by the sensor located at the end of the funnel. After the vend cycle is completed and the customer had retrieved its product the VM Controller verifies the status of the spiral. If it finds that the spiral had moved less than 360 degrees, that motor is again activated for the remaining of the cycle; if the spiral had moved past 360 degrees no further action will be taken. The obvious advantage of this routine is that the majority of the spirals will still be aligned after many vend cycles and the event of delivery of multiple products when only one was paid for is considerably reduced. Note that the VMC is the same as described in relation with FIG. 1 or FIG. 2, however not visible because is located behind the solid portion of the Vending Machine.

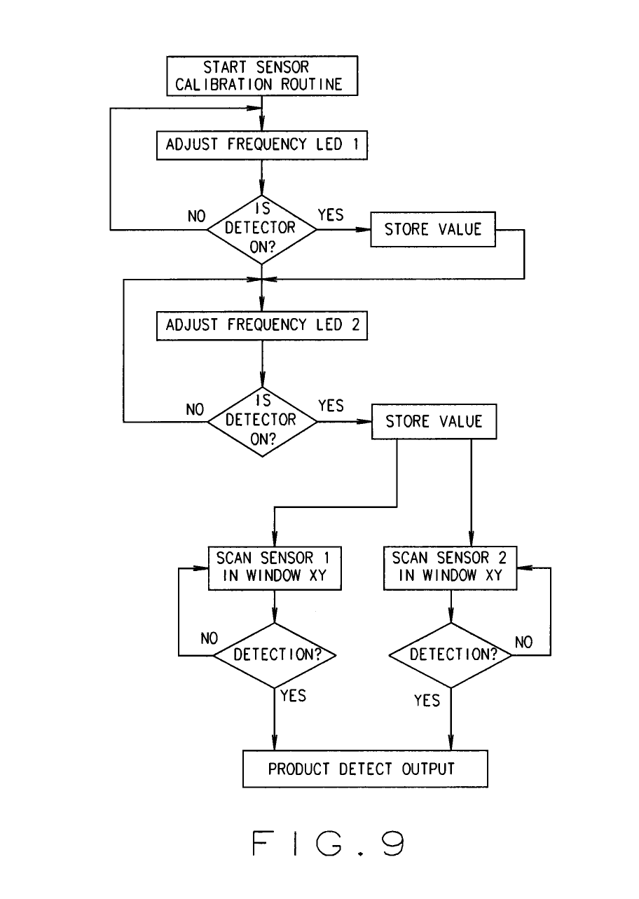

Another aspect of this invention is shown in FIG. 9. The optical sensor located at the bottom of the funnel is calibrated using a routine with 4 steps as described in the diagram of FIG. 9.

It is to be noted that the calibration process is continue and takes place at the same time as the delivered product detection is happening. As described above both sensors, 1 and 2 are built the same way, an LED and a detector. In FIG. 8 an alternative construction is presented where both detectors located across from the LEDs are replaced with one Reflector and one Detector located on the same side with the LEDs and receiving the reflected light from the Reflector. Regardless of the construction both sensors are continuing calibrated in order to eliminate bad effects of the ambient light and shadowing.

The LEDs are pulsed at a variable frequency selectable between 28 KHz and 48 KHz. The Detector is built in with an optical band pass filter with a center frequency at 38 kHz and 50% power point reduction at +/−3 KHz around this frequency. When the power is turned ON the calibration starts; the frequency of pulsing LED 1 and LED 2 is adjusted until the corresponding Detector detects a signal; the values are recorded. Immediately following the calibration process the scanning commences with the LEDs being pulsed at a frequency X % above the recorded value and Y % below it, here X and Y are experimentally determined, e.g. 10% and 12% respectively.

From all that has been said, it will be clear that there has thus been shown and described herein a novel product detection device which fulfills the various objects and advantages sought therefor. It will be apparent to those skilled in the art, however, that many changes, modifications, variations, and other uses of the subject product detection device are possible and contemplated. All changes, modifications, variations, and other uses and applications which do not depart from the spirit and scope of the invention are deemed to be covered by the invention, which is limited only by the claims which follow.

What is claimed is:

1. A vending machine comprising a product retrievable bin for the customer to access and retrieve delivered products, said retrievable bin having a upper side toward the inside of the vending machine that opens and allows a product to fall into the said customer retrievable bin, when a sensor detects that a product from the inside of the said vending machine had fallen on it.

2. The vending machine of claim 1 where the said upper side of the said customer retrievable bin is made of two walls positioned in a V toward the inside of the said vending machine.

3. The vending machine of claim 2 where the said V shaped upper side of the said customer bin has one of the said two walls lockable with a solenoid mechanism.

4. The vending machine of claim 1 where the said sensor to detect that a product had fallen on the said upper side of the said customer retrievable bin is an optical sensor located just above the said upper side.

5. A vending machine as described in claim 1 equipped with a Vending Machine Controller that after receiving a signal from the said optical sensor located just above the said upper side of the said customer retrievable bin showing that a product had fallen on the said upper side of the said customer retrievable bin, activates that said solenoid that in return un-locks one of the said V shaped walls of the said V shaped upper side and the said product that activated the said optical sensor falls into the said customer retrievable bin.

6. The vending machine of claim 5 where the said customer retrievable bin has an entry door for the customer to open and when the customer opens it to retrieve the said product, the said lockable upper side of the said bin locks up and restricts customer access to the inside of the vending machine.

7. A vending machine controller for a vending machine where products are located on spirals rotated by motors, and a sensor for detecting that said product has dropped into a customer accessible retrievable bin, activates the motor until receives a signal from that said product detection sensor and stops said motor if the rotation was more that 360 degrees.

8. A vending machine controller for a vending machine where products are located on spirals rotated by motors, and a sensor for detecting that said product has dropped into a customer accessible retrievable bin, activates the motor until receives a signal from that said product detection sensor and the rotation riches 360 degrees.

9. A vending machine controller for a vending machine controls the states of an optical sensor for detecting a product arrival at a location inside of that said vending machine such that the calibration mode and detection mode start when the power is turned on and continue one after the other until the product is detected by that said sensor.

10. The vending machine controller of claim 9 where during the said calibration mode the frequency of the every LED pulsing is varied between a low value and a high value until the corresponding detector detects a signal and the corresponding frequency value is noted.

11. The vending machine controller of claim 10 where during the detection mode every LED frequency of pulsing is varied between a low value and a high value function of the said noted value until the product is detected.
